(19) United States
(12) Patent Application Publication
(10) Pub. No.: US 2026/0362175 A1
(43) Pub. Date: Nov. 12, 2026

(54) L1 DATA COLLECTION

(71) Applicant: Telefonaktiebolaget LM Ericsson (publ), Stockholm (SE)

(72) Inventors: Jingya LI, Göteborg (SE); Daniel CHEN LARSSON, Lund (SE); Henrik RYDÉN, Stockholm (SE); Icaro Leonardo DA SILVA, Solna (SE); Emma WITTENMARK, Lund (SE); Yufei BLANKENSHIP, Kildeer, IL (US)

(21) Appl. No.: 19/124,989

(22) PCT Filed: Nov. 3, 2023
(86) PCT No.: PCT/CN2023/129611

§ 371 Date: Apr. 28, 2025

Related U.S. Application Data
(60) Provisional application No. 63/382,343, filed on Nov. 4, 2022.

(51) Int. Cl. H04W 24/08

(52) U.S. Cl. CPC H04W 24/08

(57) ABSTRACT

The present disclosure is related to L1 data collection. A method at a terminal device for collecting L1 data includes: obtaining a measurement configuration for L1 measurements; performing at least one L1 measurement based on at least the measurement configuration; and transmitting, to a first network node, a first message indicating a measurement result of the at least one L1 measurement, wherein the first message is an RRC message and/or an NAS message.

### CROSS-REFERENCE TO RELATED APPLICATION(S)

This application claims priority to the U.S. provisional patent application No. 63/382,343, entitled “DATA COLLECTION FOR AI ON PHY”, filed on Nov. 4, 2022, which is incorporated herein by reference in its entirety.

### TECHNICAL FIELD

The present disclosure is related to the field of telecommunication, and in particular, to a terminal device, network nodes, and methods for collecting Layer 1 (L1) data.

### BACKGROUND

Artificial Intelligence (AI) and Machine Learning (ML), according to both academia and industry, are promising tools to optimize the design of the air-interface in wireless communication networks. Example use cases include using autoencoders for channel state information (CSI) compression to reduce the feedback overhead and improve channel prediction accuracy; using deep neural networks for classifying line-of-sight (LOS) and non-LOS (NLOS) conditions to enhance the positioning accuracy; and using reinforcement learning for beam selection at the network side and/or the user equipment (UE) side to reduce the signaling overhead and beam alignment latency; and using deep reinforcement learning to learn an optimal precoding policy for complex multiple input multiple output (MIMO) precoding problems.

In Third Generation Partnership Project (3GPP) New Radio (NR) standardization work, a new release 18 study item on AI/ML for the NR air interface has started since May 2022. This study item will explore the benefits of augmenting the air-interface with features enabling improved support of AI/ML based algorithms for enhanced performance and/or reduced complexity/overhead. Through studying a few selected use cases (CSI feedback, beam management, and positioning), this study item aims at laying the foundation for future air-interface use cases leveraging AI/ML techniques.

### SUMMARY

FIG. 1 is a flow diagram illustrating an example life cycle management (LCM) model for AI on PHY (the physical layer or L1). A detailed description of different LCM stages can be found in 3GPP TSG-RAN WG1, R1-2208908, “Discussion on general aspects of AI ML framework”, which is incorporated herein by reference in its entirety.

Data Collection 110 is a stage that collects and provides input data (raw data or pre-processed data) for Model Training, Model inference and Model Monitoring. AI/ML algorithm specific data preparation (e.g., data ingestion and data refinement) is not carried out in the Data Collection stage.

Model Training 120 is a process that uses featured data in terms of training datasets and validation datasets to train an AI/ML model.

Model deployment 130 is a process of converting an AI/ML model into an executable form and delivering it to a target UE for inference where model inference 140 is to be performed.

Model inference 140 is a process of using a deployed AI/ML model to produce a set of outputs based on a set of featured inputs

Model monitoring 150 is a process that monitoring drifts in data and model or monitoring performance metrics after the model has been deployed. Based on the monitored performance, decisions like model activation, deactivation, switching, fallback, and/or selection can be taken.

### Minimization of Drive Tests (MDT) Based Data Collection Framework

MDT is a mechanism that was introduced in Long Term Evolution (LTE) and New Radio (NR) for minimizing the time and cost spent on driving test to collect measurement data at the Operations, Administration, and Maintenance (OAM). The network operators can use the collected data for network performance issue analysis or/and network deployment optimization. The general MDT concept is to configure normal UEs in the interested area to perform measurements, store the measurement results and then report it to the network. MDT based data collection is controlled by the OAM and the data collection is subject to user consent. A detailed description of radio measurement collection mechanisms for MDT can be found in TS 37.320, Radio measurement collection for Minimization of Drive Tests (MDT).

In general, there are two MDT signalling processes supported in NR, i.e., signalling based MDT and management-based MDT. For signalling based MDT (subscription-based), the configuration of the MDT measurements is for a specific UE selected by the OAM. For management-based MDT (area-based), the configuration of MDT measurements is provided from OAM to RAN, and the RAN node can select the UEs that are suitable for measurement collection.

Two types of MDT are defined in NR, and they are referred to as logged MDT and immediate MDT. For logged MDT, measurements are performed by the UE in RRC_IDLE or RRC_INACTIVE state and reported to gNB at a later point in time. Logged measurement configuration is signalled to a UE via a Radio Resource Control (RRC) message referred to as “LoggedMeasurementConfiguration”, which consists of, among other parameters, logging duration, the triggering of logging events, logging interval, trace collection entity ID. Triggering events for logged MDT include periodic measurement trigger and event-based trigger (e.g., measurement quality-based event L1 or out-of-coverage detection trigger). For Immediate MDT, measurements are performed by the UE in RRC_CONNECTED state and reporting of the measurements to RAN is available at the time of reporting condition.

From TS 38.331, v17.2.0, Section 6.2.2:

LoggedMeasurementConfiguration message

-- ASN1START
-- TAG-LOGGEDMEASUREMENTCONFIGURATION-START
LoggedMeasurementConfiguration-r16 ::= SEQUENCE {

| | |
|---|---|
| criticalExtensions | CHOICE { |
| loggedMeasurementConfiguration-r16 | LoggedMeasurementConfiguration-r16-IEs, |
| criticalExtensionsFuture | SEQUENCE { } |
| } | |
| } | |

LoggedMeasurementConfiguration-r16-IEs ::= SEQUENCE {

| | |
|---|---|
| traceReference-r16 | TraceReference-r16, |
| traceRecordingSessionRef-r16 | OCTET STRING (SIZE (2)), |
| tce-Id-r16 | OCTET STRING (SIZE (1)), |
| absoluteTimeInfo-r16 | AbsoluteTimeInfo-r16, |
| areaConfiguration-r16 | AreaConfiguration-r16 |
| OPTIONAL, -- Need R | |
| plmn-IdentityList-r16 | PLMN-IdentityList2-r16 |
| OPTIONAL, -- Need R | |
| bt-NameList-r16 | SetupRelease {BT-NameList-r16} |
| OPTIONAL, -- Need M | |
| wlan-NameList-r16 | SetupRelease {WLAN-NameList-r16} |
| OPTIONAL, -- Need M | |
| sensor-NameList-r16 | SetupRelease {Sensor-NameList-r16} |
| OPTIONAL, -- Need M | |
| loggingDuration-r16 | LoggingDuration-r16, |
| reportType | CHOICE { |
| periodical | LoggedPeriodicalReportConfig-r16, |
| eventTriggered | LoggedEventTriggerConfig-r16, |
| ... | |
| }, | |
| lateNonCriticalExtension | OCTET STRING |
| OPTIONAL, | |
| nonCriticalExtension | LoggedMeasurementConfiguration-v1700-IEs OPTIONAL |
| } | |

LoggedMeasurementConfiguration-v1700-IEs ::= SEQUENCE {

| | |
|---|---|
| sigLoggedMeasType-r17 | ENUMERATED {true} |
| OPTIONAL, -- Need R | |
| earlyMeasIndication-r17 | ENUMERATED {true} |
| OPTIONAL, -- Need R | |
| areaConfiguration-v1700 | AreaConfiguration-v1700 |
| OPTIONAL, -- Need R | |
| nonCriticalExtension | SEQUENCE { } OPTIONAL |
| } | |
| LoggedPeriodicalReportConfig-r16 ::= | SEQUENCE { |
| loggingInterval-r16 | LoggingInterval-r16, |
| ... | |
| } | |
| LoggedEventTriggerConfig-r16 :: = | SEQUENCE { |
| eventType-r16 | EventType-r16, |
| loggingInterval-r16 | LoggingInterval-r16, |
| ... | |
| } | |
| EventType-r16 ::= CHOICE { | |
| outOfCoverage NULL, | |

```
    eventL1  SEQUENCE {
      l1-Threshold MeasTriggerQuantity,
      hysteresis  Hysteresis,
      timeToTrigger  TimeToTrigger
```

```
    },
    ...
}
```

-- TAG-LOGGEDMEASUREMENTCONFIGURATION-STOP
-- ASN1STOP

There currently exist certain challenges. For example, for AI on PHY use cases, e.g., channel state information (CSI) feedback compression, downlink spatial beam prediction, and downlink temporal beam prediction, Layer-1 measurement data are needed for the network to train an AI/ML model and/or perform model monitoring.

The MDT-based data collection framework cannot support the data collection for model training/monitoring for the AI on PHY use cases, because the existing MDT measurement configuration cannot support a UE to perform L1 radio measurements and report it to the network. The uplink control information (UCI) based CSI reporting framework does not fit to the data collection for model training/monitoring either, because the payload size for UCI is limited. In addition, the signaling overhead would be too high, because the network requires much more data to be collected for AI/ML model training and performance model monitoring that the existing data that is reported to assist procedures such as beam management, link adaptation, etc.

Certain aspects of the disclosure and their embodiments may provide solutions to these or other challenges. For example, particular embodiments include a radio measurement and UE reporting configuration method to support a UE to log/store layer-1 measurement data for one or multiple measurement occasions, and then report the (accumulated) measurement result(s) to a network node using a RRC message(s).

According to a first aspect of the present disclosure, a method at a terminal device is provided. The method comprises: obtaining a measurement configuration for Layer 1 (L1) measurements; performing at least one L1 measurement based on at least the measurement configuration; and transmitting, to a first network node, a first message indicating a measurement result of the at least one L1 measurement. In some embodiments, the first message is a Radio Resource Control (RRC) message and/or a Non-Access Stratum (NAS) message.

According to a second aspect of the present disclosure, a terminal device is provided. The terminal device comprises: a processor; a memory storing instructions which, when executed by the processor, cause the terminal device to: obtain a measurement configuration for L1 measurements; perform at least one L1 measurement based on at least the measurement configuration; and transmit, to a first network node, a first message indicating a measurement result of the at least one L1 measurement. In some embodiments, the first message is a Radio Resource Control (RRC) message and/or a Non-Access Stratum (NAS) message. In some embodiments, the instructions, when executed by the processor, further cause the terminal device to perform any of the methods of the first aspect.

According to a third aspect of the present disclosure, a terminal device is provided. The terminal device comprises: an obtaining module configured to obtain a measurement configuration for L1 measurements; a performing module configured to perform at least one L1 measurement based on at least the measurement configuration; and a transmitting module configured to transmit, to a first network node, a first message indicating a measurement result of the at least one L1 measurement. In some embodiments, the first message is a Radio Resource Control (RRC) message and/or a Non-Access Stratum (NAS) message. In some embodiments, the terminal device comprises one or more further modules, each of which may perform any of the steps of any of the methods of the first aspect.

According to a fourth aspect of the present disclosure, a method at a first network node is provided. The method comprises: transmitting, to a terminal device, a second message indicating a measurement configuration for L1 measurements; and receiving, from the terminal device, a first message indicating a measurement result of at least one L1 measurement. In some embodiments, the first message is a Radio Resource Control (RRC) message and/or a Non-Access Stratum (NAS) message.

According to a fifth aspect of the present disclosure, a first network node is provided. The first network node comprises: a processor; a memory storing instructions which, when executed by the processor, cause the terminal device to: transmit, to a terminal device, a second message indicating a measurement configuration for L1 measurements; and receive, from the terminal device, a first message indicating a measurement result of at least one L1 measurement. In some embodiments, the first message is a Radio Resource Control (RRC) message and/or a Non-Access Stratum (NAS) message. In some embodiments, the instructions, when executed by the processor, further cause the first network node to perform any of the methods of the fourth aspect.

According to a sixth aspect of the present disclosure, a first network node is provided. The first network node comprises: a transmitting module configured to transmit, to a terminal device, a second message indicating a measurement configuration for L1 measurements; and a receiving module configured to receive, from the terminal device, a first message indicating a measurement result of at least one L1 measurement. In some embodiments, the first message is a Radio Resource Control (RRC) message and/or a Non-Access Stratum (NAS) message. In some embodiments, the first network node comprises one or more further modules, each of which may perform any of the steps of any of the methods of the fourth aspect.

According to a seventh aspect of the present disclosure, a computer program comprising instructions is provided. The instructions, when executed by at least one processor, cause the at least one processor to carry out any of the methods of any of the first aspect and the fourth aspect.

According to an eighth aspect of the present disclosure, a carrier containing the computer program of the seventh aspect is provided. In some embodiments, the carrier is one of an electronic signal, optical signal, radio signal, or computer readable storage medium.

According to a ninth aspect of the present disclosure, a telecommunication system is provided. The telecommunication system comprises: a terminal device and a first network node. In some embodiments, the first network node comprises: a processor; a memory storing instructions which, when executed by the processor, cause the first network node to: transmit, to the terminal device, a second message indicating a measurement configuration for L1 measurements; and receive, from the terminal device, a first message indicating a measurement result of at least one L1 measurement. In some embodiments, the first message is a Radio Resource Control (RRC) message and/or a Non-Access Stratum (NAS) message. In some embodiments, the terminal device comprises: a processor; a memory storing instructions which, when executed by the processor, cause the terminal device to: obtain the measurement configuration; perform the at least one L1 measurement based on at least the measurement configuration; and transmit, to the first network node, the first message. In some embodiments, the instructions stored in the memory of the terminal device, when executed by the processor of the terminal device, further cause the terminal device to perform any of the methods of the first aspect. In some embodiments, the instructions stored in the memory of the first network node, when executed by the processor of the first network node, further cause the first network node to perform any of the methods of the fourth aspect.

Certain embodiments may provide one or more of the following technical advantages. For example, particular embodiments enable a network to collect large amount of layer-1 measurement data together with other non-radio-measurement data from UE reports, and the network can use the collected data for model training and/or model monitoring for AI on PHY use cases.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary life cycle management (LCM) model for AI on PHY.

FIG. 2 to FIG. 4 are diagrams illustrating exemplary configurations of time windows according to some embodiments of the present disclosure.

FIG. 5 is a diagram illustrating an exemplary method for reducing reporting overhead according to an embodiment of the present disclosure.

FIG. 6 is a flow chart illustrating an exemplary method at a terminal device according to an embodiment of the present disclosure.

FIG. 7 is a flow chart illustrating an exemplary method at a first network node according to an embodiment of the present disclosure.

FIG. 8 schematically shows an embodiment of an arrangement which may be used in a terminal device and/or a network node according to an embodiment of the present disclosure.

FIG. 9 is a block diagram of an exemplary terminal device according to an embodiment of the present disclosure.

FIG. 10 is a block diagram of an exemplary first network node according to an embodiment of the present disclosure.

FIG. 11 shows an example of a communication system in accordance with some embodiments of the present disclosure.

FIG. 12 shows an exemplary User Equipment (UE) in accordance with some embodiments of the present disclosure.

FIG. 13 shows an exemplary network node in accordance with some embodiments of the present disclosure.

FIG. 14 is a block diagram of an exemplary host, which may be an embodiment of the host of FIG. 11, in accordance with various aspects described herein.

FIG. 15 is a block diagram illustrating an exemplary virtualization environment in which functions implemented by some embodiments may be virtualized.

FIG. 16 shows a communication diagram of an exemplary host communicating via an exemplary network node with an exemplary UE over a partially wireless connection in accordance with some embodiments of the present disclosure.

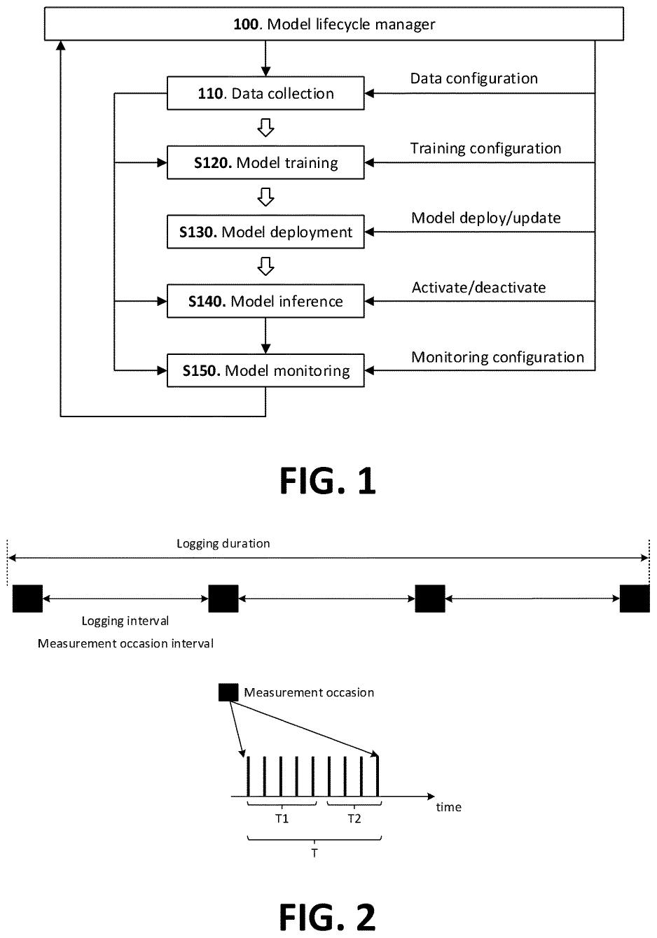

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as L1 data collection is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, 6th generation (6G) mobile system standard, etc. Therefore, one skilled in the arts could readily understand that the terms used herein may also refer to their equivalents in any other infrastructure. For example, the term “communication device” used herein may refer to a UE, a terminal device, a mobile device, a mobile terminal, a mobile station, a user device, a user terminal, a wireless device, a wireless terminal, a transmission reception point (TRP), a base station, a base transceiver station, an access point, a hot spot, a NodeB, an Evolved NodeB (eNB), a gNB, a network element, a satellite, an aircraft, a device that is capable of communicating with other devices, or any other equivalents.

Further, following 3GPP documents are incorporated herein by reference in their entireties:
[1] 3GPP TSG-RAN WG1 Meeting #110-bis-e, Tdoc R1-2208908, Online, Oct. 10-19, 2022, “Discussion on general aspects of AI/ML framework”; and
[2] 3GPP TS 37.320 V17.1.0 (2022-06), Technical Specification, 3rd Generation Partnership Project; Technical Specification Group Radio Access Network; Radio measurement collection for Minimization of Drive Tests (MDT); Overall description; Stage 2 (Release 17).

As mentioned above, certain aspects of the disclosure and their embodiments may provide solutions to these or other challenges. For example, particular embodiments include a radio measurement and UE reporting configuration method to support a UE to log/store layer-1 measurement data for one or multiple measurement occasions, and then report the accumulated data to a network node using a RRC message(s).

The radio measurement and reporting configuration consists of one or more of: i) a measurement occasion configuration parameter, which is defined as a single Downlink Reference Signal (DL-RS) resource set or a burst of multiple RS resource sets over different time instances. The configuration of a DL-RS resource set may correspond to one or more Synchronous Signal/PBCH (Physical Broadcast Channel) block (SSB) indexes (e.g. SSB index 1, . . . , SSB index K), or one or more Channel State Information Reference Signal (CSI-RS) indexes (e.g., CSI-RS index 1, . . . , CSI-RS index K), or one or more SSB and CSI-RS indexes (CSI-RS index 1, . . . , CSI-RS index K1, SSB index 1, . . . , SSB index K2). The DL-RS resources are associated to a cell e.g. with a Physical Cell Identifier (PCI) and SSB frequency information. The cell that is associated to the DL-RS resource set may be a serving cell the UE is configured with while the UE is in RRC_CONNECTED state (and indicated in the configuration by a serving cell index or by the fact that the configuration is included in the serving cell configuration for that serving cell), or a neighbor cell in a serving frequency or in a neighbor frequency.

Based on the measurement and reporting configuration, the UE performs one or more measurements, logs/stores the measurement results performed at least one of the configured measurement occasion together with other requested data if available. The UE reports the accumulated/collected data when a certain data reporting condition is met, e.g., at the end of the configured data collection period, when receiving a data reporting request from the network, etc.

In general, particular embodiments include a radio measurement and reporting configuration that configures one or multiple measurement occasions, where each measurement occasion consists of one- or multiple DL-RS resource sets at one- or multiple-time instances. A UE performs L1-measurements on the configured measurement resources, logs the measurements together with other types of data if available, and reports the accumulated data to the network via an RRC message(s).

Certain embodiments may provide one or more of the following technical advantages. For example, particular embodiments enable a network to collect large amount of layer-1 measurement data together with other non-radio-measurement data from UE reports, and the network can use the collected data for model training and/or model monitoring for AI on PHY use cases.

### Additional Explanation

Some of the embodiments will now be described more fully with reference to the accompanying drawings. Embodiments are provided by way of example to convey the scope of the subject matter to those skilled in the art.

The terms “ML-model” and “AI-model” are used interchangeably herein. An AI/ML model can be defined as a functionality or be part of a functionality that is deployed/implemented in a first node. The first node can receive a message from a second node indicating that the functionality is not performing correctly, e.g. prediction error is higher than a pre-defined value, error interval is not in acceptable levels, or prediction accuracy is lower than a pre-defined value. Further, an AI/ML model can be defined as a feature or part of a feature that is implemented/supported in a first node. The first node can indicate the feature version to a second node. If the ML-model is updated, the feature version may be changed by the first node.

An ML-model may correspond to a function that receives one or more inputs (e.g. measurements) and provide as output one or more prediction(s)/estimates of a certain type. In one example, an ML-model may correspond to a function receiving as input the measurement of a reference signal at time instance t0 (e.g. transmitted in beam-X) and provide as output the prediction of the reference signal in time t0+T. In another example, an ML-model may correspond to a function receiving as input the measurement of a reference signal X (e.g. transmitted in beam-x), such as an SSB whose index is ‘x’, and provide as output the prediction of other reference signals transmitted in different beams e.g. reference signal Y (e.g. transmitted in beam-y), such as an SSB whose index is ‘y’. Another example is a ML model for aid in CSI estimation, in such a setup the ML-model will be specific ML-model with a UE and an ML-model within the network (NW) side. Jointly both ML-models provide joint network. The function of the ML-model at the UE would be to compress a channel input and the function of the ML-model at the NW side would be to decompress the received output from the UE. It is further possible to apply something similar for positioning wherein the input may be a channel impulse in some form related to a certain reference point (typically a TP (transmit point)) in time. The purpose on the NW side would be to detect different peaks within the impulse response, that reflects the multipath experienced by the radio signals arriving at the UE side. For positioning another way is to input multiple sets of measurements into an ML network and based on that derive an estimated position of the UE. Another ML-model would be an ML-model to be able to aid the UE in channel estimation or interference estimation for channel estimation. The channel estimation could for example be for the PDSCH and be associated with specific set of reference signals patterns that are transmitted from the NW to the UE. The ML-model will then be part of the receiver chain within the UE and may not be directly visible within the reference signal pattern as such that is configured/scheduled to be used between the NW and UE. Another example of an ML-model for CSI estimation is to predict a suitable Channel Quality Information (CQI), Precoding Matrix Indicator (PMI), Rank Indicator (RI), CSI-RS Resource Indicator (CRI) or similar value into the future. The future may be a certain number of slots after the UE has performed the last measurement or targeting a specific slot in time within the future.

The network, NW, as used herein, can be one of a generic NW node, gNB, base station, unit within the base station to handle at least some ML operation, relay node, core network node, a core network node that handle at least some ML operations, a device supporting D2D communication, a LMF or other types of location server.

### Layer-1 Measurement and Data Logging Configuration

Particular embodiments include a network signaling and UE reporting method to support a network node to collect layer-1 radio measurement data based on UE report(s). The NW may configure the UE to report non-measurement data together with the radio measurements.

The latency requirement for NW to obtain training data can be relaxed as compared to that for model inference. Thus, it is good that a UE can log/store its radio measurements together with the assistance information (e.g., time stamps, cell ID (global cell ID with PLMN, cell identity or physical cell ID), PLMN, area ID(s) (e.g., one or more registration area identifier(s), tracking area code(s), RAN notification area ID(s), location area ID, or routing area ID), and/or UE location and/or frequency information such as SSB frequency, point A frequency, etc.) for multiple measurement occasions, and then report these accumulated data to the NW using a higher layer message, e.g., a RRC message or a NAS message. Comparing to the layer-1 CSI reporting method over PUCCH/and PUSCH based on CSI-MeasConfig received while in RRC_CONNETED, a method for reporting using a higher-layer message (e.g., RRC message) based data collection solution can enable the NW to collect larger amounts of measurement data (to assist AI/ML at the network side) from a UE with reduced signaling overhead and radio resource consumption. This also allows the possibility of performing data collection while in RRC_IDLE or RRC_INACTIVE (not possible with existing layer-1 CSI reporting method, only possible when the UE is in RRC_CONNECTED). Note that, the data collected here are different from MDT type of data, as they are layer-1 radio measurement data.

In addition, the report of the collected data over RRC, after Access Stratum (AS) security has been activated, provides a secure mechanism to report a large amount of sensitive information to the network e.g. UE location, trajectory, etc.

The data types to be measured and logged by the UE are use case dependent. However, in general, they can be divided into two types: radio measurement data and non-radio-measurement data. For the beam prediction use cases (e.g. prediction of SSB indexes the UE may move to, or L1 RSRP of one or more SSB indexes, cell quality, etc.), the radio measurement data can include L1-RSRP, L1-RSRQ, SS-RSRP, SS-RSRQ, measurements on CSI-RS resources, L1-SINR, and/or CRI/SSBRI, and the non-radio measurement data can include, for example, cell-ID (including serving cell and/or neighbor cell), PLMN, area ID, carrier frequency, bandwidth, subcarrier-spacing (SCS), time stamp and/or UE location. For the CSI compression use case, the radio measurement data can include the high-resolution channel H (as the target data for model training) and the non-radio measurement data can include cell-ID, area ID, time stamp, carrier frequency, bandwidth, SCS, etc. For the positioning use case, the radio measurement data can include rich channel impulse response information and the non-radio measurements can include for example cell-ID (including serving cell and/or neighbor cell), time stamp and UE location.

In an embodiment, a measurement configuration message is defined for configuring a UE to perform layer-1 measurements and log the measurement results together with other available data. As an example, this message is an RRC message. The measurement configuration message may correspond to an RRC message including a measurement configuration for layer-1 measurements (e.g. an instance of the IE CSI-MeasConfig, or one or more parameters such as the ones defined in CSI-MeasConfig defined in TS 38.331) to be performed and logged e.g. for assistance of AI/ML training at the network. The existing CSI-MeasConfig defined in TS 38.331 contains both a CSI reporting configuration (e.g. at least one CSI-ReportConfig) and resource configurations, however, according to one embodiment it is primarily one or more resource configuration(s) which would be used by the UE for performing the measurements for data collection e.g. a set of SSB(s) and SSB properties such as frequency, SMTC, SSBs in a burst per frequency and/or cell.

In an embodiment, the measurement configuration message configures the list of data types to log and report.
In one example, the list of data types includes those that correspond to both the AI/ML model input(s) and the model output(s). Note here that the AI/ML model input(s) and output(s) can be the input and output to a feature. This quantity for example for use case of beam prediction can be L1-RSRP or SINR (it is just that the measurement is time series or/and spread many DL RS signaling (beams)). For the positioning use case the input can for example be rich channel information or time of arrival estimates and the output can for example be UE location. This is useful for training data collection to support supervised learning.
   For the data correspond to the model output(s), the collected data is intended to be ground truth labels for supervised training, e.g., for time-domain beam prediction, the best beam at a future time instance T2 corresponding to model input measured at time T1. In real life deployment, it is impractical to expect error-free ground truth labels. Thus it is also useful to log the estimated error rate or uncertainty level of the ground truth labels. If the UE is unable to generate the ground truth label as expected, the measurement report then report an error value, and may also report an error cause (e.g., beam failure, radio link interruption).
In another example, the set of data types include those that correspond to the AI/ML model input(s) only. This is useful for training data collection to support unsupervised learning or semi-supervised learning. This is also useful for model monitoring.
In another example, the list of data types correspond to the output(s) of an intermediate layer of the AI/ML model. For example, the output from the n^{th} neural network layer. This could be done in order to reduce the dimensionality of the data to be reported in comparison to reporting the input directly. While still enabling higher dimensionalities than only reporting the output value, which might be too granular (e.g. in case of binary output).

In an embodiment, the measurement configuration message configures the UE a timer value for a measurement timer. The UE starts the measurement timer with the configured value when the UE receives the configuration and/or when the UE starts to perform the measurements. When the measurement timer expires, the UE is not required to continue performing the measurements. Or, alternatively the UE stops performing the measurements. In other words, the UE performs the measurement configured by the measurement configuration message while the measurement timer is running.

In an embodiment, the UE stores the collected data for a limited amount of time. In one option the UE starts a data storage timer when the UE stops to perform the measurements. In one option the UE starts a data storage timer when the UE starts to perform the measurements. When the data storage timer expires the UE deletes/releases/discards the stored measurements.

In a set of embodiments, while the UE is in IDLE or INACTIVE state, performing the measurements for data collection to assist AI/ML, the UE performs cell reselection. When the UE is configured to perform these measurements while in IDLE or INACTIVE state for the cell the UE is camping on, the UE notifies the network when it performs a cell reselection, so the network may start transmitting resources to be measured, such as CSI-RS resources. Otherwise, resources from multiple cells and/or nodes may need to be transmitted without the network even having the certainty that the UE is in suitable coverage to detect the signals and perform the required measurements.

In an embodiment, the measurement configuration message configures one or more measurement occasions, where a measurement occasion can be configured with a single RS resource set or a burst of multiple RS resource sets at different time instances.

The configuration of RS resource set(s) for a measurement occasion can be use case dependent.

For example, for spatial beam prediction use case, a measurement occasion can be configured with a single set of CSI-RS/SSB resources that are mapped to a set of beams including both the beams in the measurement set (Set B of beams) and the beams in the prediction set (Set A of beams).

For temporal beam prediction use case, a measurement occasion can consist of multiple sets of CSI-RS/SSB resources, where different resource sets are associated to different time instances. Consider a case where the measurement beams (Set B of beams) at different time instances within the observation window (T1) are not changed, and the prediction targets (set A of beams) for the future time instances within the prediction window (T2) are also fixed, then, a measurement occasion for this use case can be configured to consist of multiple sets of RS resources at different time instances within a time window (T, where T>=T1+T2), where each resource set at a time instance consists of RS resources mapped to Set A and Set B of beams. For time-domain prediction type of AI on PHY use cases, it is important that the number of time instances (or the time window) configured for a measurement occasion covers both the observation time instances/window (related to model input) and the prediction time instances/window (related to model output). Note here that the model input and model output will be what is use by the network later.

For temporal beam prediction use case, another way of RS resource configuration for data collection is to configure a UE with a single set of CSI-RS/SSB resources, where the CSI-RS resources, if exist, are configured with a periodicity and they can be received by the UE at each measurement occasion. Similarly, the SSB resources, if configured in the resource set, are configured with a periodicity. Further it is so that the observation time window (T1) and prediction time window (T2) can be extended to the case where the UE measures the CSI-RS/SSB resources within both the time window T1 and T2. The time windows then reappear with the periodicity of a logging interval. Note further that the time window T2 may not exist and there is instead a long window T1. There may further be multiple time windows within each measurement occasion, i.e. more than 2.

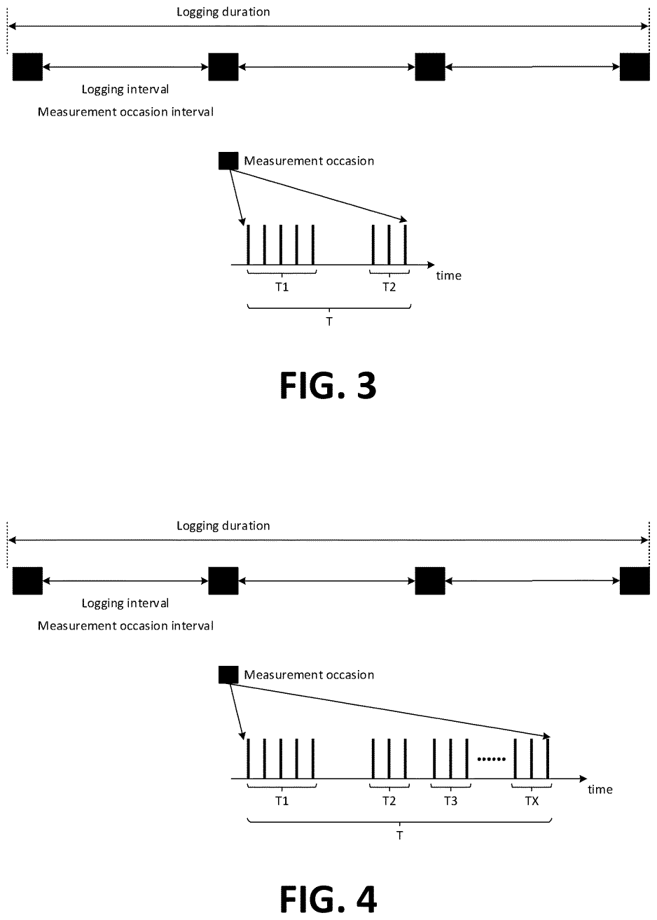

Examples of different configurations of T1 and T2 and T are illustrated in FIG. 2 and FIG. 3. In the figures the bars above times T1 and T2 represents the CSI-RS/SSB resources that are received by the UE. The difference between the figures is that in FIG. 3 there is gap between T1 and T2 while in FIG. 2 they are adjacent to each other. If further there is no interest in predicting into the future there is no need to have window T2 but instead just configure T1. Alternatively, this is realized by putting T1 and T2 next to each other as shown in FIG. 2. Further it is possible to generalize this to multiple windows which is shown in FIG. 4. This up to window TX.

Similarly, the concept of measurement window for the CSI-RS configuration described above may be extended to support the configuration of periodicity and indication of lacking CSI-RS presence outside the measurement windows. This can be done by having the similar configuration for the CSI-RS as for the actual measurement setup. Alternatively, it can be so that the UE may assume that the CSI-RS is not present for measurement (at least for this type of measurement) if it is outside a configured window. Similar extension is possible to indicate the SSBs or other DL RS resources that the UE shall measure on or skip measure on.

In an embodiment, a measurement occasion is configured with multiple RS resource set within a time window, where the time window is greater than or equal to the observation time period plus the prediction time period for model inference.

In an embodiment, a measurement occasion interval is defined to support periodic radio measurements and logging at the UE.

In an embodiment, a UE performs Layer-1 radio measurements at each configured measurement occasion and logs the measurement data together with other non-radio-measurement data if available. Hence, the logging interval is equal to the measurement occasion interval.

In an embodiment, the measurement configuration message also configures the data collection duration, e.g., by defining a time window or timer during which a UE performs radio measurements and data logging.

In an embodiment, the measurement configuration message configures the data format for its logged data. For instance, a UE only logs the top-K beams per each time instance per measurement occasion, or a threshold condition is configured for UE to decide which L1-RSRP/RSSI/SINR measurement results should be logged, or whether the UE shall log a high-resolution channel representation or a low-resolution channel representation, etc.

In an embodiment, the measurement configuration message configures the Radio Access Technology (RAT)-independent information. For instance,
configuration of the WLAN access point names, indicating the UE to attempt to obtain WLAN measurements associated to these access points.
configuration of the Bluetooth beacon names, indicating the UE to attempt to obtain Bluetooth measurements associated to these beacons.
configuration of the sensor names, indicating the UE to attempt to obtain sensor measurements.

The logged RAT-independent information may be used to support data fusion in the AI/ML model.

In one embodiment, the measurements are performed while the UE is in CONNECTED state. That may be performed based on the measurement configuration received in an RRCReconfiguration message. Alternatively, that may be performed based on the measurement configuration received in an RRC Resume message, when the UE transitions from INACTIVE state to CONNECTED.

In one embodiment, the measurements are performed while the UE is in IDLE state. That may be performed based on the measurement configuration received in an RRC Release message. Alternatively, the measurement configuration may have been received while the UE was in RRC_CONNECTED, but were possibly suspended until the UE entered IDLE state.

In one embodiment, the measurements are performed while the UE is in INACTIVE state. That may be performed based on the measurement configuration received in an RRC Release message. Alternatively, the measurement configuration may have been received while the UE was in RRC_CONNECTED, but were possibly suspended until the UE entered INACTIVE state.

In an embodiment, the measurement configuration message configures the area where the measurements should be performed. For example, the area can be configured in terms of a Cell-ID, a tracking area, a PLMN, or a combination of any of the above.

### Data Logging Triggers

Different events and conditions can be defined for triggering a UE to start performing radio measurements and data logging.

In an embodiment, a UE can start performing radio measurements and data logging after receiving the measurement configuration message from the NW, or a timing offset parameter is contained in the measurement configuration message to indicate the time to starting measure and log the data, or a DCI signalling is used to trigger one or multiple UEs to start radio measurement and data logging.

The data collection can also be event-based or event-triggered. The events and conditions for triggering radio measurements and data logging at UE can be different for different use cases.

In an embodiment, the measurement configuration message is an RRC message sent from an gNB to the UE.
The RRC message may correspond to an RRC Release message which upon reception transitions the UE to RRC_IDLE state. That includes the measurement configuration to be used by the UE while in RRC_IDLE for performing the measurements to be later collected by the network, such as when the UE transitions to RRC_CONNECTED (RRC establishment procedure).
The RRC message may correspond to an RRC Release message including a suspend configuration (e.g. suspendConfig), or a suspend message, which upon reception transitions the UE to RRC_INACTIVE state. That includes the measurement configuration to be used by the UE while in RRC_IDLE for performing the measurements to be later collected by the network, such as when the UE transitions to RRC_CONNECTED (RRC resume procedure).
The RRC message may correspond to an RRC Reconfiguration message. Then, upon reception of an RRC Release the UE transitions to RRC_IDLE state or RRC_INACTIVE state (if the message includes a suspendConfig), so that the measurement configuration for data collection (received while the UE was in RRC_CONNECTED) is stored and used while the UE is in RRC_IDLE or RRC_INACTIVE. That RRC Reconfiguration message includes the measurement configuration to be used by the UE while in RRC_IDLE for performing the measurements to be later collected by the network, such as when the UE transitions to RRC_CONNECTED (RRC establishment procedure).

In an embodiment, for beam management use cases, measurement and data logging can be triggered when the UE experiences Transmission Configuration Indicator (TCI) state switches (TX beams switches) above a certain maximum number within a configured time window, or when UE experiences a certain number of beam failures within a time window.

In an embodiment, the UE can be configured by the NW to trigger measurement if its velocity is above or below a certain threshold. If the event is later triggered the UE start to measure according to its configure and later report the results to the NW.

In an embodiment, the UE can be configured by the NW to trigger measurements if its doppler shift is above or below a certain threshold. If the event is later triggered the UE start to measure according to its configure and later report the results to the NW.

In an embodiment, the UE can be configured by the NW to trigger measurements if its measured best DL RS signal has changed a given number of times within a given time interval. The given number of times can either be configured by the NW or given in the specification and the time interval can either be configured by the NW or be given in the specification. If the event is later triggered the UE start to measure according to its configure and later report the results to the NW. In a further limitation to the above the DL RS could be RS limited to a certain Quasi Co-Location (QCL) type only e.g. QCL-type D. The later here for example to capture just spatial changes.

In an embodiment, the event that triggered the measurement is stored and report together with the measured data.

In one embodiment, the event is handover. The handover command contains a configuration as to whether the UE shall retain the logged measurements, or the UE shall discard logged measurements. If the UE retains these measurements, then there can be additional configuration as to whether the UE shall continue to log these measurements or whether the UE shall suspend these measurements. The configuration could further involve when the UE can send the measurement report.

In one embodiment, the event is state transition from RRC connected to RRC idle/RRC inactive. In another sub embodiment, the RRC release message contains a configuration as to whether the UE shall retain these measurements, or the UE shall discard these measurements. If the UE retains these measurements, then there can be additional configuration as to whether the UE shall continue to log these measurements or whether the UE shall suspend these measurements.

In one embodiment, the event is cell selection and/or cell reselection. In another sub embodiment, the measurement configuration indicates to the UE one or more cells (e.g. by configuring one or more cell identifiers like CGI(s), PCIs+ARFCN, etc.) for which the UE performs the measurements to be stored for data collection. These may be structured per frequency layers e.g. for a given SSB frequency the UE may be configured with one or more PCI(s).
When the UE transitions from CONNECTED to IDLE or INACTIVE the UE performs cell selection, and if the selection cell is a cell indicated in the measurement configuration the UE perform the measurements and stored them, so they can be possibly requested by the network.
While the UE is in RRC_IDLE or RRC_INACTIVE, the UE performs cell reselection and, if the reselected cell is a cell in the measurement configuration the UE perform the measurements and stored them, so they can be possibly requested by the network.

In an embodiment, it is a combination of the above embodiments.

### Data Reporting Triggers

Different events and conditions can be defined for triggering a UE to report the logged data to the NW.

In an embodiment, UE is configured to report the logged data periodically. In another embodiment, the data reporting is triggered by a DCI signaling, which schedules a UE to report the logged data as an RRC message on PUSCH.

In another embodiment, the UE is triggered to report the data to the NW if a time elapses within the UE. The UE will in such a case if it is in IDLE or INACTIVE state go to CONNECTED mode. After which the UE will report the data to the NW.

In another embodiment, data reporting is triggered when certain conditions are met, e.g., when the UE detects a beam failure, or when the number of TCI state switches (TX beam switches) is above a certain number within a time window. Another time window may be defined/configured so that a UE only needs to report part of the logged data to the NW, e.g., only report the data that are related to the latest N measurement occasions close to the beam failure.

In another embodiment, the UE is triggered to report the data to the NW upon reception of a request.

### Reporting Overhead Reduction

In one embodiment, prior to reporting the logged data. The UE performs processing of the logged data to reduce its size, for reporting overhead reduction.

In one example, a weight is stored for each sample in the logged dataset, i.e., the dataset consists of tuples ([[x1,w1]; [x2,w2], . . . , [xn,wn]]) where xi is the i-th sample and wi is its corresponding weight. The weight of a sample can be increased if a new sample is the closest in terms of a certain distance criterion. For example, we can increase w1 if a new sample is closest to x1 of the database samples, and within threshold range of x1.

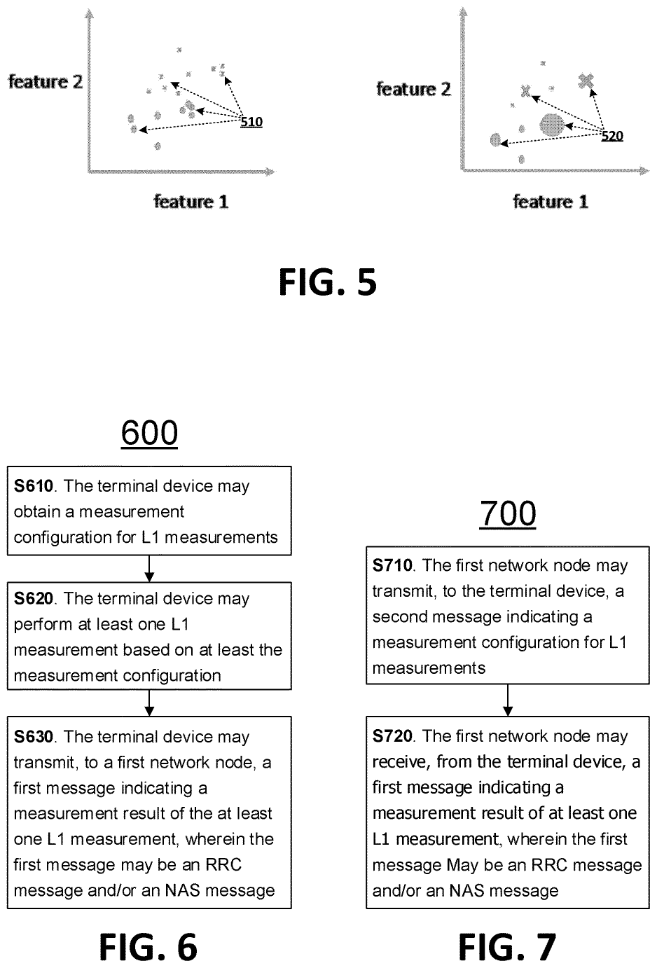

This is exemplified by FIG. 5 for a situation when the feature is RSRP1/2, it could comprise any type of feature. The size of the point illustrates the weight Wₛₐₘₚₗₑ. Note that the sample weight will affect the ML model training.

As shown in FIG. 5, samples logged are shown in the left portion. In the right portion of FIG. 5, an example where 4 samples of different weights indicated by the arrows 520 are created from the corresponding samples indicated by the arrows 510 is provided, thus reducing the consumed memory and UE reporting overhead.

Note that the sample weight can affect the model training, for example by including the sample weight in the optimization function. A typical optimization is to minimize the mean squared error of the model output and the true value, i.e.:

$$MSE = \frac{1}{N} \sum {( f ( x ) - {y}_{true} )}^{2}$$

The sample weight can be included by adding an additional sample weight term:

$$MSE = \frac{1}{N} {\sum }_{s} {{w}_{s} ( f ( {x}_{s} ) - {y}_{true \_ s} )}^{2}$$

where the MSE is calculated for all stored N samples.

In another example, the reduction is performed by create new artificial sample(s). The UE can also perform clustering metrics such as k-means to reduce the database to k samples. As a non-limiting example, the UE can be configured to produce k-samples using the k-means method. Other examples can be clustering, self-organizing maps and principal component analysis.

In another example, the UE can delete sample(s).

If the database can only store a certain number of N samples (or a UE can only report N samples), and the new sample(s) is giving a total population of N+X samples then the network has to discard or delete X samples to keep the population to the size of N. The selection of which points to be picked (N) or be deleted (X) can be done on different available methods. For picking N number of samples where the summed Euclidian distance of all sample-pairs is maximized can be used. Another method is to use as aforementioned the ML model prediction if present as a decision criterion, to remove samples that already have an accurate prediction.

With the embodiments described above, a network may be enabled to collect large amount of layer-1 measurement data together with other non-radio-measurement data from UE reports, and the network can use the collected data for model training and/or model monitoring for AI on PHY use cases.

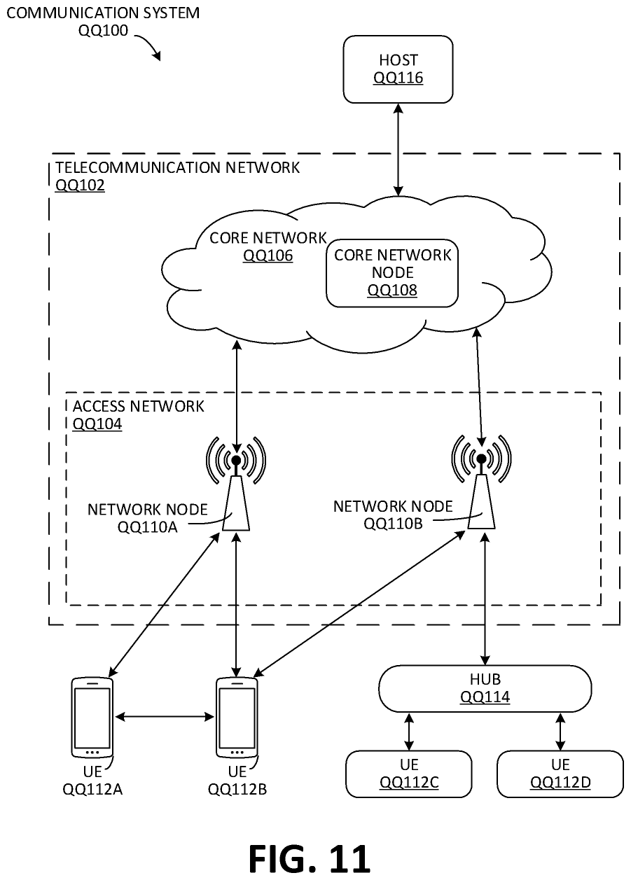

FIG. 6 is a flow chart illustrating an exemplary method 600 at a terminal device according to an embodiment of the present disclosure. The method 600 may be performed at a terminal device (e.g., the terminal device 900 shown in FIG. 9 or the UEs QQ112A through QQ112D shown in FIG. 11). The method 600 may comprise steps S610, S620, and S630. However, the present disclosure is not limited thereto. In some other embodiments, the method 600 may comprise more steps, less steps, different steps, or any combination thereof. Further the steps of the method 600 may be performed in a different order than that described herein when multiple steps are involved. Further, in some embodiments, a step in the method 600 may be split into multiple sub-steps and performed by different entities, and/or multiple steps in the method 600 may be combined into a single step.

The method 600 may begin at step S610 where the terminal device may obtain a measurement configuration for L1 measurements.

At step S620, the terminal device may perform at least one L1 measurement based on at least the measurement configuration.

At step S630, the terminal device may transmit, to a first network node, a first message indicating a measurement result of the at least one L1 measurement. In some embodiments, the first message may be a Radio Resource Control (RRC) message and/or a Non-Access Stratum (NAS) message.

In some embodiments, before the step of transmitting the first message, the method 600 may further comprise: logging, at the terminal device, the measurement result of the at least one L1 measurement. In some embodiments, the measurement configuration may be at least one of: a measurement configuration from the first network node or a second network node; a pre-configured measurement configuration; and a hardcoded measurement configuration. In some embodiments, the measurement configuration may indicate the terminal device to report non-measurement data together with the measurement result. In some embodiments, the measurement configuration may indicate a list of data types to be measured, logged, and/or reported by the terminal device.

In some embodiments, one or more data types to be measured, logged, and/or reported for the at least one L1 measurement and/or the non-measurement data to be logged and/or reported may be use case dependent. In some embodiments, the non-measurement data to be logged and/or reported may comprise at least one of: at least one time stamp; at least one cell identifier (ID); at least one Public Land Mobile Networks (PLMNs); at least one area ID; at least one location of the terminal device; and at least one frequency information. In some embodiments, one or more data types to be measured, logged, and/or reported for the at least one L1 measurement may comprise at least one of: L1 Reference Signal Received Power (RSRP); L1 Reference Signal Received Quality (RSRQ); Synchronous Signal (SS) RSRP; SS RSRQ; a measurement on Channel State Information Reference Signal (CSI-RS) resources; L1 Signal to Interference plus Noise Ratio (SINR); CSI-RS Resource Indicator (CRI); Synchronous Signal/Physical Broadcast Channel Block (SSB) Resource Indicator (SSBRI); channel model information; and channel impulse response information.

In some embodiments, at least one of the L1 measurements may be performed when the terminal device is in one of a connected state, an idle state, and an inactive state. In some embodiments, a list of data types to be measured, logged, and/or reported, which is indicated by the measurement configuration, may correspond to at least one of: input data to an Artificial Intelligence (AI)/Machine Learning (ML) model; and output data from an AI/ML model; intermediate data from an intermediate layer of an AI/ML model; an estimated error rate for the output data; an uncertainty level for the output data; an error value for the output data; and an error cause for the output data.

In some embodiments, the measurement configuration may further indicate at least one of: a first timer value, wherein a first timer may be started with the first timer value when the terminal device obtains the measurement configuration and/or when the terminal device starts performing the at least one L1 measurement, and wherein the terminal device may be not required to continue performing the at least one L1 measurement and/or stop performing the at least one L1 measurement when the first timer is expired; a second timer value, wherein a second timer may be started with the second timer value when the terminal device starts or stops performing the at least one L1 measurement, and wherein the terminal device may delete, release, or discard measurement results that are stored when the second timer is expired; a time window during which the terminal device may perform the at least one L1 measurement and/or logging; and a data format for data logging; Radio Access Technology (RAT) independent information; and an area where the at least one L1 measurement is to be performed.

In some embodiments, when the at least one L1 measurement is to be performed for a cell by the terminal device in an idle or inactive state, the method 600 may further comprise: transmitting, to a network node, a message indicating when the terminal device performs a cell reselection to the cell. In some embodiments, the measurement configuration may indicate one or more measurement occasions for L1 measurements. In some embodiments, each of the measurement occasions may be associated with one or more reference signal (RS) resource sets for L1 measurements. In some embodiments, a configuration of the one or more RS resource sets associated with a measurement occasion may be use case dependent. In some embodiments, when the use case is spatial beam prediction, a measurement occasion may be configured with a single set of CSI-RS and/or SSB resources that are mapped to a set of beams comprising both beams in a measurement set and beams in a prediction set.

In some embodiments, when the use case is temporal beam prediction, a measurement occasion may be configured with multiple sets of CSI-RS and/or SSB resources that are associated with different time instances, respectively. In some embodiments, when the use case is temporal beam prediction, a measurement occasion may be configured with a single set of CSI-RS and/or SSB resources that are configured with a periodicity. In some embodiments, one or more measurement windows associated with a measurement occasion may cover an observation time window associated with a time domain prediction type of AI/ML model. In some embodiments, the one or more measurement windows may further cover a prediction time window associated with the time domain prediction type of AI/ML model.

In some embodiments, a measurement occasion may be defined such that periodic radio measurements and/or logging at the terminal device are supported. In some embodiments, the terminal device may perform the at least one L1 measurement at each configured measurement occasion and logs at least one measurement result together with non-measurement data if available. In some embodiments, a logging interval may be equal to a measurement occasion interval.

In some embodiments, when the measurement configuration is obtained via a Radio Resource Control (RRC) message from a network node, the RRC message may be at least one of: an RRCRelease message, wherein the terminal device may be transitioned by the RRC message to an idle or inactive state, and the measurement configuration is to be used by the terminal device in the idle or inactive state; an RRCReconfiguration message, wherein the RRC message may be received before the terminal device is transitioned to an idle or inactive state, and the measurement configuration is to be used by the terminal device in the idle or inactive state; an RRCReconfiguration message, wherein the RRC message may be received when the terminal device is in a connect state, and the measurement configuration is to be used by the terminal device in the connected state; and an RRCResume message, wherein the terminal device may be transitioned by the RRC message to a connect state, and the measurement configuration is to be used by the terminal device in the connected state.

In some embodiments, the at least one L1 measurement and/or logging may be started to be performed in response to one or more first trigger events and/or conditions, which may comprise at least one of: the measurement configuration is obtained by the terminal device; a time to start measuring and/or logging indicated by the measurement configuration is reached; downlink control information (DCI) for triggering the terminal device to start measurement and/or logging is received; and the terminal device has a velocity faster than or slower than a threshold; the terminal device has a Doppler shift higher than or lower than a threshold; the measured best downlink (DL) RS has changed a given number of times within a given time interval; a handover for the terminal device is triggered; a state transition for the terminal device is triggered; and a cell selection and/or cell reselection for the terminal device is triggered. In some embodiments, the DL RS may be an RS limited to a specific Quasi-Co-Location (QCL) type only. In some embodiments, the one or more first trigger events and/or conditions may be use case dependent. In some embodiments, when the use case is beam management, the one or more first trigger events and/or conditions may comprise at least one of: a number of Transmission Configuration Indictor (TCI) switches or transmission (TX) beam switches, which are experienced by the terminal device within a time window, is greater than a threshold; and a number of beam failures, which are experienced by the terminal device within a time window, is greater than a threshold. In some embodiments, the first message may further indicate the event and/or condition that triggered the at least one L1 measurement and/or logging.

In some embodiments, the transmission of the first message may be started in response to one or more second trigger events and/or conditions, which may comprise at least one of: a periodically occurred trigger event; DCI signalling, which schedules the terminal device to report the measurement result, is received by the terminal device; a specific time elapses; a state transition of the terminal device from an idle or inactive state to a connected state; detection of a beam failure; and a number of TCI state switches or TX beam switches, which are experienced by the terminal device within a time window, is greater than a threshold; and reception of a request.

In some embodiments, before the step of transmitting the first message, the method 600 may further comprise: processing the measurement result to reduce its size. In some embodiments, the step of processing the measurement result to reduce its size may comprise: assigning a weight to each sample data in the measurement result; increasing a first weight associated with a first sample data when one or more other sample data fall in a threshold range of the first sample data; removing the one or more other sample data from the measurement result. In some embodiments, the first message may further indicate the first weight in addition to the first sample data. In some embodiments, the first weight is also used for training an AI/ML model with the first sample data. In some embodiments, the step of processing the measurement result to reduce its size may comprise: performing clustering, self-organizing, and/or principal component analysis (PCA) on the measurement result, such that a less number of new sample data is created when compared with the measurement result; and replacing the sample data in the measurement result with the new sample data. In some embodiments, the step of processing the measurement result to reduce its size may comprise: deleting sample data from the measurement result.

FIG. 7 is a flow chart illustrating an exemplary method 700 at a first network node according to an embodiment of the present disclosure. The method 700 may be performed at a network node (e.g., the first network node 1000 shown in FIG. 10 or the network nodes QQ110A through QQ110B shown in FIG. 11). The method 700 may comprise steps S710 and S720. However, the present disclosure is not limited thereto. In some other embodiments, the method 700 may comprise more steps, different steps, or any combination thereof. Further the steps of the method 700 may be performed in a different order than that described herein when multiple steps are involved. Further, in some embodiments, a step in the method 700 may be split into multiple sub-steps and performed by different entities, and/or multiple steps in the method 700 may be combined into a single step.

The method 700 may begin at step S710 where the first network node may transmit, to the terminal device, a second message indicating a measurement configuration for L1 measurements.

At step S720, the first RAN node may receive, from the terminal device, a first message indicating a measurement result of at least one L1 measurement.

In some embodiments, the first message may be a Radio Resource Control (RRC) message and/or a Non-Access Stratum (NAS) message.

In some embodiments, the measurement configuration may indicate the terminal device to report non-measurement data together with the measurement result. In some embodiments, the measurement configuration may indicate a list of data types to be measured, logged, and/or reported by the terminal device. In some embodiments, one or more data types to be measured, logged, and/or reported for the at least one L1 measurement and/or the non-measurement data to be logged and/or reported may be use case dependent. In some embodiments, the non-measurement data to be logged and/or reported may comprise at least one of: at least one time stamp; at least one cell identifier (ID); at least one Public Land Mobile Networks (PLMNs); at least one area ID; at least one location of the terminal device; and at least one frequency information.

In some embodiments, one or more data types to be measured, logged, and/or reported for the at least one L1 measurement may comprise at least one of: L1 Reference Signal Received Power (RSRP); L1 Reference Signal Received Quality (RSRQ); Synchronous Signal (SS) RSRP; SS RSRQ; a measurement on Channel State Information Reference Signal (CSI-RS) resources; L1 Signal to Interference plus Noise Ratio (SINR); CSI-RS Resource Indicator (CRI); Synchronous Signal/Physical Broadcast Channel Block (SSB) Resource Indicator (SSBRI); channel model information; and channel impulse response information. In some embodiments, at least one of the L1 measurements may be performed when the terminal device is in one of a connected state, an idle state, and an inactive state. In some embodiments, a list of data types to be measured, logged, and/or reported, which is indicated by the measurement configuration, may correspond to at least one of: input data to an Artificial Intelligence (AI)/Machine Learning (ML) model; and output data from an AI/ML model; intermediate data from an intermediate layer of an AI/ML model; an estimated error rate for the output data; an uncertainty level for the output data; an error value for the output data; and an error cause for the output data.

In some embodiments, the measurement configuration may further indicate at least one of: a first timer value, wherein a first timer may be started with the first timer value when the terminal device obtains the measurement configuration and/or when the terminal device starts performing the at least one L1 measurement, and wherein the terminal device may be not required to continue performing the at least one L1 measurement and/or stops performing the at least one L1 measurement when the first timer is expired; a second timer value, wherein a second timer may be started with the second timer value when the terminal device starts or stops performing the at least one L1 measurement, and wherein the terminal device may delete, release, or discard measurement results that are stored when the second timer is expired; a time window during which the terminal device performs the at least one L1 measurement and/or logging; and a data format for data logging; Radio Access Technology (RAT) independent information; and an area where the at least one L1 measurement is to be performed.

In some embodiments, when the at least one L1 measurement is to be performed for a cell by the terminal device in an idle or inactive state, the method 700 may further comprise: receiving, from the terminal device, a message indicating when the terminal device performs a cell reselection to the cell. In some embodiments, the method 700 may further comprise: transmitting one or more RSs associated with the at least one L1 measurement after the terminal performs the cell reselection to the cell if the cell is served by the first network node.

In some embodiments, the measurement configuration may indicate one or more measurement occasions for L1 measurements. In some embodiments, each of the measurement occasions may be associated with one or more reference signal (RS) resource sets for L1 measurements. In some embodiments, a configuration of the one or more RS resource sets associated with a measurement occasion may be use case dependent. In some embodiments, when the use case is spatial beam prediction, a measurement occasion may be configured with a single set of CSI-RS and/or SSB resources that are mapped to a set of beams comprising both beams in a measurement set and beams in a prediction set. In some embodiments, when the use case is temporal beam prediction, a measurement occasion may be configured with multiple sets of CSI-RS and/or SSB resources that are associated with different time instances, respectively. In some embodiments, when the use case is temporal beam prediction, a measurement occasion may be configured with a single set of CSI-RS and/or SSB resources that are configured with a periodicity.

In some embodiments, one or more measurement windows associated with a measurement occasion may cover an observation time window associated with a time domain prediction type of AI/ML model. In some embodiments, the one or more measurement windows may further cover a prediction time window associated with the time domain prediction type of AI/ML model. In some embodiments, a measurement occasion may be defined such that periodic radio measurements and/or logging at the terminal device are supported. In some embodiments, the terminal device may perform the at least one L1 measurement at each configured measurement occasion and log at least one measurement result together with non-measurement data if available. In some embodiments, a logging interval may be equal to a measurement occasion interval.

In some embodiments, when the measurement configuration is transmitted to the terminal device via a Radio Resource Control (RRC) message, the RRC message may be at least one of: an RRCRelease message, wherein the terminal device may be transitioned by the RRC message to an idle or inactive state, and the measurement configuration is to be used by the terminal device in the idle or inactive state; an RRCReconfiguration message, wherein the RRC message may be received before the terminal device is transitioned to an idle or inactive state, and the measurement configuration is to be used by the terminal device in the idle or inactive state; an RRCReconfiguration message, wherein the RRC message may be received when the terminal device is in a connect state, and the measurement configuration is to be used by the terminal device in the connected state; and an RRCResume message, wherein the terminal device may be transitioned by the RRC message to a connect state, and the measurement configuration is to be used by the terminal device in the connected state.

In some embodiments, the at least one L1 measurement and/or logging may be started to be performed by the terminal device in response to one or more first trigger events and/or conditions, which may comprise at least one of: the measurement configuration is obtained by the terminal device; a time to start measuring and/or logging indicated by the measurement configuration is reached; downlink control information (DCI) for triggering the terminal device to start measurement and/or logging is received; and the terminal device has a velocity faster than or slower than a threshold; the terminal device has a Doppler shift higher than or lower than a threshold; the measured best downlink (DL) RS associated with the terminal device has changed a given number of times within a given time interval; a handover for the terminal device is triggered; a state transition for the terminal device is triggered; and a cell selection and/or cell reselection for the terminal device is triggered. In some embodiments, the DL RS may be an RS limited to a specific Quasi-Co-Location (QCL) type only. In some embodiments, the one or more first trigger events and/or conditions may be use case dependent. In some embodiments, when the use case is beam management, the one or more first trigger events and/or conditions may comprise at least one of: a number of Transmission Configuration Indictor (TCI) switches or transmission (TX) beam switches, which are experienced by the terminal device within a time window, is greater than a threshold; and a number of beam failures, which are experienced by the terminal device within a time window, is greater than a threshold. In some embodiments, the first message may further indicate the event and/or condition that triggered the at least one L1 measurement and/or logging.

In some embodiments, the reception of the first message may be started in response to one or more second trigger events and/or conditions, which may comprise at least one of: a periodically occurred trigger event; DCI signalling, which schedules the terminal device to report the measurement result, is transmitted to the terminal device; a specific time elapses; a state transition of the terminal device from an idle or inactive state to a connected state; detection of a beam failure; and a number of TCI state switches or TX beam switches, which are experienced by the terminal device within a time window, is greater than a threshold; and transmission of a request.

In some embodiments, the first message may indicate a first sample data in the measurement result and its associated weight. In some embodiments, the associated weight may also be used for training an AI/ML model with the first sample data. In some embodiments, the first network node may be a RAN node.

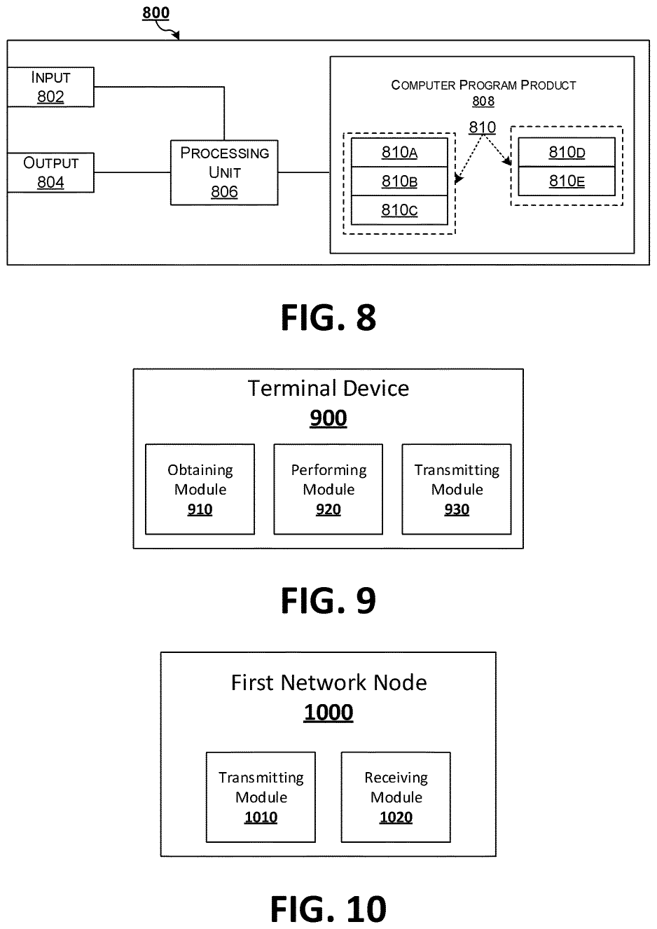

FIG. 8 schematically shows an embodiment of an arrangement 800 which may be used in a terminal device and/or network nodes according to an embodiment of the present disclosure. Comprised in the arrangement 800 are a processing unit 806, e.g., with a Digital Signal Processor (DSP) or a Central Processing Unit (CPU). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity or as separate entities.

Furthermore, the arrangement 800 may comprise at least one computer program product 808 in the form of a non-volatile or volatile memory, e.g., an Electrically Erasable Programmable Read-Only Memory (EEPROM), a flash memory and/or a hard drive. The computer program product 808 comprises a computer program 810, which comprises code/computer readable instructions, which when executed by the processing unit 806 in the arrangement 800 causes the arrangement 800 and/or the terminal device and/or the network node in which it is comprised to perform the actions, e.g., of the procedure described earlier in conjunction with FIG. 2 through FIG. 7 or any other variant.

The computer program 810 may be configured as a computer program code structured in computer program modules 810A, 810B, and 810C. Hence, in an exemplifying embodiment when the arrangement 800 is used in a terminal device, the code in the computer program of the arrangement 800 includes: a module 810A configured to obtain a measurement configuration for L1 measurements; a module 810B configured to perform at least one L1 measurement based on at least the measurement configuration; and a module 810C configured to transmit, to a first network node, a first message indicating a measurement result of the at least one L1 measurement. In some embodiments, the first message is a Radio Resource Control (RRC) message and/or a Non-Access Stratum (NAS) message.

Additionally or alternatively, the computer program 810 may be further configured as a computer program code structured in computer program modules 810D and 810E. Hence, in an exemplifying embodiment when the arrangement 800 is used in a first network node the code in the computer program of the arrangement 800 includes: a module 810D configured to transmit, to a terminal device, a second message indicating a measurement configuration for L1 measurements; and a module 810E configured to receive, from the terminal device, a first message indicating a measurement result of at least one L1 measurement. In some embodiments, the first message may be a Radio Resource Control (RRC) message and/or a Non-Access Stratum (NAS) message.

The computer program modules could essentially perform the actions of the flow illustrated in FIG. 2 through FIG. 7, to emulate the terminal device and/or the network node. In other words, when the different computer program modules are executed in the processing unit 806, they may correspond to different modules in the terminal device and/or the network node.

Although the code means in the embodiments disclosed above in conjunction with FIG. 8 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the terminal device and/or the network node.

Correspondingly to the method 600 as described above, an exemplary terminal device is provided. FIG. 9 is a block diagram of a terminal device 900 according to an embodiment of the present disclosure. The terminal device 900 may be, e.g., the UE QQ112A through QQ112D in some embodiments.

The terminal device 900 may be configured to perform the method 600 as described above in connection with FIG. 6. As shown in FIG. 9, the terminal device 900 may comprise: an obtaining module 910 configured to obtain a measurement configuration for L1 measurements; a performing module 920 configured to perform at least one L1 measurement based on at least the measurement configuration; and a transmitting module 930 configured to transmit, to a first network node, a first message indicating a measurement result of the at least one L1 measurement. In some embodiments, the first message may be a Radio Resource Control (RRC) message and/or a Non-Access Stratum (NAS) message.

The above modules 910, 920, and 930 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the terminal device 900 may comprise one or more further modules, each of which may perform any of the steps of the method 600 described with reference to FIG. 6.

Correspondingly to the method 700 as described above, an exemplary first network node is provided. FIG. 10 is a block diagram of a first network node 1000 according to an embodiment of the present disclosure. The first network node 1000 may be, e.g., the network nodes QQ110A through QQ110B in some embodiments.

The first network node 1000 may be configured to perform the method 700 as described above in connection with FIG. 7. As shown in FIG. 10, the first network node 1000 may comprise: a transmitting module 1010 configured to transmit, to the terminal device, a second message indicating a measurement configuration for L1 measurements; and a receiving module 1020 configured to receive, from the terminal device, a first message indicating a measurement result of at least one L1 measurement. In some embodiments, the first message may be a Radio Resource Control (RRC) message and/or a Non-Access Stratum (NAS) message.

The above modules 1010 and 1020 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the first network node 1000 may comprise one or more further modules, each of which may perform any of the steps of the method 700 described with reference to FIG. 7.

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

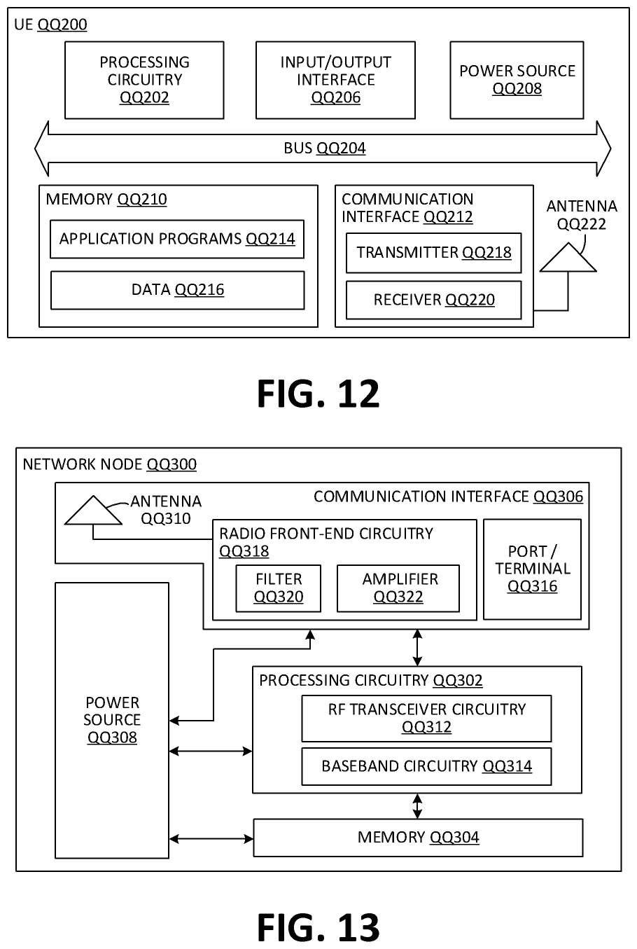

FIG. 12 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAS), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

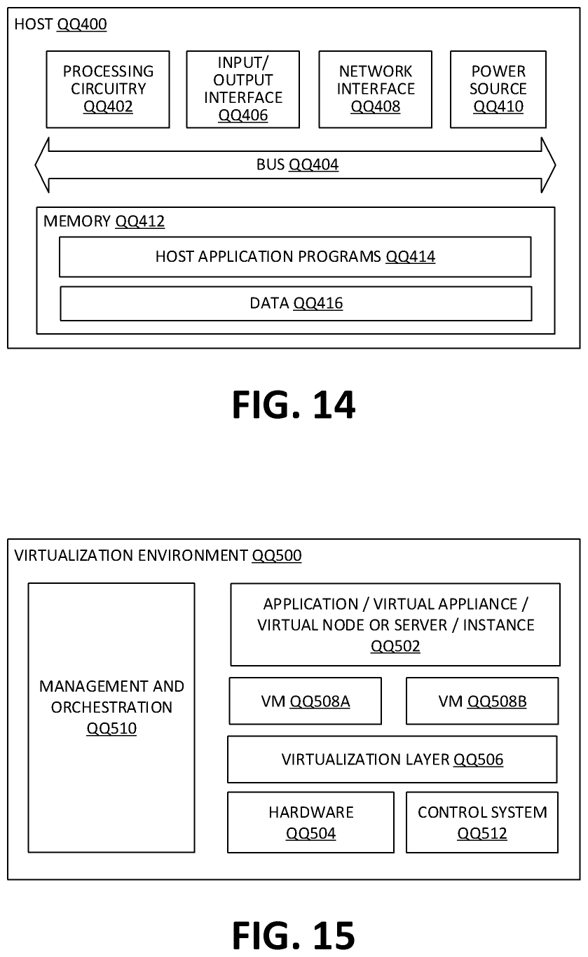

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 12 and FIG. 13, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each includes one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

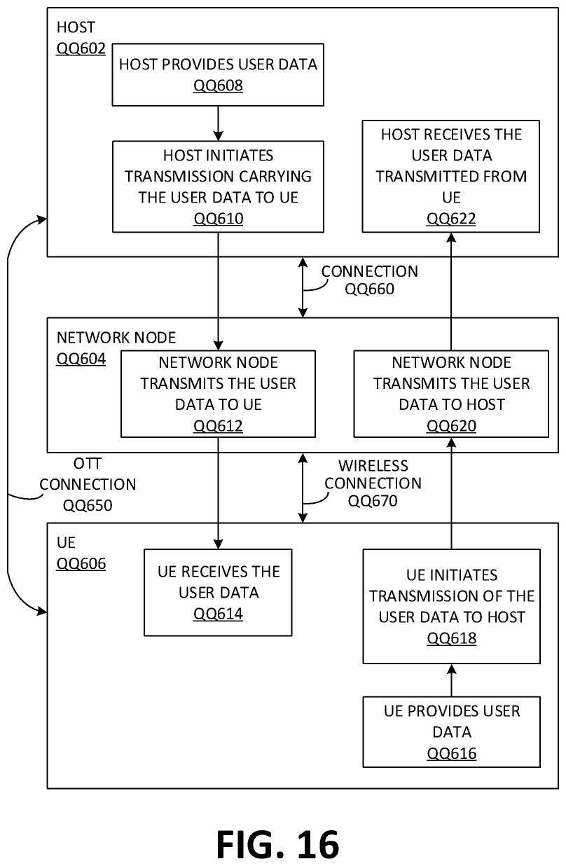

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| DL | Downlink |
| DMRS | Demodulation Reference Signals |
| ML | Machine learning |
| NW | Network |
| SINR | Signal to Interference and Noise Ratio |
| UE | User equipment |
| UL | Uplink |

1. A method at a terminal device, the method comprising:
obtaining a measurement configuration for Layer 1 measurements;
performing at least one L1 measurement based on at least the measurement configuration; and
transmitting, to a first network node, a first message indicating a measurement result of the at least one L1 measurement, the first message being one or both of a Radio Resource Control (RRC) message and a Non-Access Stratum (NAS) message.

2. The method of claim 1, wherein before transmitting the first message, the method further comprises:
logging, at the terminal device, the measurement result of the at least one L1 measurement.

3. The method of claim 1, wherein the measurement configuration is at least one of:
a measurement configuration from the first network node or a second network node;
a pre-configured measurement configuration; and
a hardcoded measurement configuration.

4. The method of claim 1, wherein the measurement configuration indicates the terminal device to report non-measurement data together with the measurement result.

5. The method of claim 1, wherein the measurement configuration indicates a list of data types to be one or more of measured, logged, and reported by the terminal device.

6. The method of claim 1, wherein one or more data types to be one or more of measured, logged, and reported for the one or both of at least one L1 measurement and the non-measurement data to be one or both logged and reported are use case dependent.

7. The method of claim 4, wherein the non-measurement data to be one or both logged and reported comprises at least one of:
at least one time stamp;
at least one cell identifier (ID);
at least one Public Land Mobile Networks (PLMNs);
at least one area ID;
at least one location of the terminal device; and
at least one frequency information.

8. The method of claim 1, wherein one or more data types to be one or more of measured, logged, and reported for the at least one L1 measurement comprises at least one of:
L1 Reference Signal Received Power (RSRP);
L1 Reference Signal Received Quality (RSRQ);
Synchronous Signal (SS) RSRP;
SS RSRQ;
a measurement on Channel State Information Reference Signal (CSI-RS) resources;
L1 Signal to Interference plus Noise Ratio (SINR);
CSI-RS Resource Indicator (CSI);
Synchronous Signal/Physical Broadcast Channel Block (SSB) Resource Indicator; (SSBRI);
channel model information; and
channel impulse response information.

9. The method of claim 1, wherein
at least one of the L1 measurements is performed when the terminal device is in one of a connected state, an idle state, and an inactive state.

10. The method of claim 1, wherein a list of data types to be one or more of measured, logged, and reported, which is indicated by the measurement configuration, correspond to at least one of:
input data to an Artificial Intelligence (AI)/Machine Learning (ML) model; and
output data from an AI/ML model;
intermediate data from an intermediate layer of an AI/ML model;
an estimated error rate for the output data;
an uncertainty level for the output data;
an error value for the output data; and
an error cause for the output data.

11. The method of claim 1, wherein the measurement configuration further indicates at least one of:
a first timer value, wherein a first timer is started with the first timer value when one or both the terminal device obtains the measurement configuration and when the terminal device starts performing the at least one L1 measurement, and wherein the terminal device is one or both not required to continue performing the at least one L1 measurement and stops performing the at least one L1 measurement when the first timer is expired;
a second timer value, wherein a second timer is started with the second timer value when the terminal device starts or stops performing the at least one L1 measurement, and wherein the terminal device deletes, releases, or discards measurement results that are stored when the second timer is expired;
a time window during which the terminal device performs the one or both of the at least one L1 measurement and the logging; and
a data format for data logging;
Radio Access Technology (RAT) independent information; and
an area where the at least one L1 measurement is to be performed.

12. The method of claim 1, wherein when the at least one L1 measurement is to be performed for a cell by the terminal device in an idle or inactive state, the method further comprises:
transmitting, to a network node, a message indicating when the terminal device performs a cell reselection to the cell.

13. The method of claim 1, wherein the measurement configuration indicates one or more measurement occasions for L1 measurements, wherein each of the measurement occasions is associated with one or more reference signal (RS) resource sets for L1 measurements.

14. The method of claim 13, wherein a configuration of the one or more RS resource sets associated with a measurement occasion is use case dependent.

15. The method of claim 14, wherein when the use case is spatial beam prediction, a measurement occasion is configured with a single set of one or both CSI-RS and SSB resources that are mapped to a set of beams comprising both beams in a measurement set and beams in a prediction set.

16. The method of claim 14, wherein when the use case is temporal beam prediction, a measurement occasion is configured with multiple sets of one or both CSI-RS and SSB resources that are associated with different time instances, respectively.

17. The method of claim 14, wherein when the use case is temporal beam prediction, a measurement occasion is configured with a single set of one or both CSI-RS and SSB resources that are configured with a periodicity.

18.-22. (canceled)

23. The method of claim 1, wherein the one or both of the at least one L1 measurement and logging are started to be performed in response to one or both one or more first trigger events and conditions, which comprise at least one of:
the measurement configuration is obtained by the terminal device;
a time to start one or both measuring and logging indicated by the measurement configuration is reached;
downlink control information for triggering the terminal device to start measurement and/or logging is received; and
the terminal device has a velocity faster than or slower than a threshold;
the terminal device has a Doppler shift higher than or lower than a threshold;
the measured best downlink (DL) RS has changed a given number of times within a given time interval;
a handover for the terminal device is triggered;
a state transition for the terminal device is triggered; and
a cell selection and/or cell reselection for the terminal device is triggered.

24.-33. (canceled)

34. A terminal device for collecting Layer 1 data, the terminal device comprising:
a processor;
a memory storing instructions which, when executed by the processor, cause the terminal device to:
obtain a measurement configuration for L1 measurements;
perform at least one L1 measurement based on at least the measurement configuration; and
transmit, to a first network node, a first message indicating a measurement result of the at least one L1 measurement, the first message being one or both of a Radio Resource Control (RRC) message and a Non-Access Stratum (NAS) message.

35. (canceled)

36. A method at a first network node, the method comprising:
transmitting, to a terminal device, a second message indicating a measurement configuration for L1 measurements;
receiving, from the terminal device, a first message indicating a measurement result of at least one L1 measurement,
wherein the first message is one or both of a Radio Resource Control (RRC) message and a Non-Access Stratum (NAS) message.

37.-71. (canceled)
